(19) United States
(12) Patent Application Publication
(10) Pub. No.: US 2006/0285828 A1
(43) Pub. Date: Dec. 21, 2006

(54) Video recording apparatus and video recording method

(76) Inventors: Masataka Moteki, Ome-shi (JP); Seigo Ito, Hanno-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/454,841

(22) Filed: Jun. 19, 2006

(30) Foreign Application Priority Data
Jun. 20, 2005 (JP) 2005-179396

(51) Int. Cl. H04N 7/00

(52) U.S. Cl. 386/95

(57) ABSTRACT

To provide a video recorder and video recording method according to an embodiment is setting a management information recording area for writing management information of optional number of files defined based on a data size of a recording image, in a recording medium configured to hold file data, and securing a data recording area for recording optional number of files, corresponding to the set management information recording area. This method prevents a decrease in a seek speed, when recording information (file data) in an optical disc provided with a metadata partition.

### CROSS-REFERENCE TO RELATED APPLICATIONS

This application is based upon and claims the benefit of priority from Japanese Patent Application No. 2005-179396, filed Jun. 20, 2005, the entire contents of which are incorporated herein by reference.

### BACKGROUND

1. Field

One embodiment of the invention relates to a video recording apparatus and video recording method, which can prevent a decrease in a seek speed when recording, erasing or playing back information in/from an optical disc recordable, erasable or playable information by using a laser beam.

2. Description of the Related Art

A DVD-standard optical disc has been put to practical use a long time ago. As a file system standard, DVD-Video (for play-only software) UDF (Universal Disc Format) 1.02 and DVD-VR (for a recordable disc) UDF 2.00 have been developed and used. UDF 2.50 has been developed for a next-generation optical disc (HD DVD, Blue-Ray) with increased recording density.

Comparing with the UDF 2.00, the UDF 2.50 adopts a structure called a metadata partition. This enables collective storage of management information such as FE (File Entry) and FID (File Identifier Descriptors) in a metadata partition. This is useful to increase the information seeking speed.

For example, Japanese Patent Application Publication (KOKAI) No. H9-251406 describes the acquisition of a logical information number, not physical number information, to recognize an expanded partition as one partition when expanding a partition area.

However, when recording a still image on a next-generation optical disc (HD DVD, Blue-Ray) with the recording capacity increased to several times larger than a DVD-standard optical disc, the number of images will reach several thousands to several ten thousands. Particularly, when a still image is of JPEG standard, one still image is stored in one file and the number of files is increased as the number of recording images is increased. In this case, the number of management information becomes the same as the number of files.

This means the possibility of dividing a metadata file expressing a metadata partition by the expansion furthermore depending on the prerecorded data state on a recording medium, though a metadata partition used for the UDF 2.50 is used.

Namely, when recording a JEPG image (file), if the metadata partition is expanded as the number of files is increased, the metadata file becomes easy to be divided furthermore. In this case, the advantage of metadata partition is not utilized and the user's convenience is lost. For example, the data reading/writing time may be increased.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary diagram showing an example of an information recording/playback apparatus according to the present invention;

FIG. 2 is an exemplary diagram showing an example of a data structure of a UDF 2.50;

FIG. 3 is an exemplary diagram showing an example of characteristic parts of the data structure of the UDF 2.50 shown in FIG. 2;

FIG. 4 is an exemplary diagram showing an example of a data structure when a metadata partition is expanded;

FIG. 5 is an exemplary flowchart showing an example of a first means embodying the invention;

FIG. 6 is an exemplary diagram showing an example of a data structure on a recording medium at the time when the series of blocks shown in the flowchart of FIG. 5;

FIG. 7 is an exemplary flowchart showing an example of a process of recording a still image;

FIG. 8 is an exemplary diagram showing an example of a data structure in a recording medium immediately after recording a still image according to the flowchart shown in FIG. 7;

FIG. 9 is an exemplary diagram showing an example of a data structure in a recording medium immediately after recording a still image, different from that of FIG. 8;

FIG. 10 is an exemplary flowchart showing an example of a second means of embodying the invention;

FIG. 11 is an exemplary diagram showing an example of a data structure in a recording medium at the time when the series of blocks shown in the flowchart of FIG. 10; and

FIG. 12 is an exemplary diagram showing an example of a data structure in a recording medium immediately after recording a still image according to the flowchart shown in FIG. 11.

### DETAILED DESCRIPTION

Various embodiments according to the invention will be described hereinafter with reference to the accompanying drawings. In general, according to one embodiment of the invention, a video recorder and video recording method according to an embodiment is setting a management information recording area for writing management information of optional number of files defined based on a data size of a recording image, in a recording medium configured to hold file data, and securing a data recording area for recording optional number of files, corresponding to the set management information recording area.

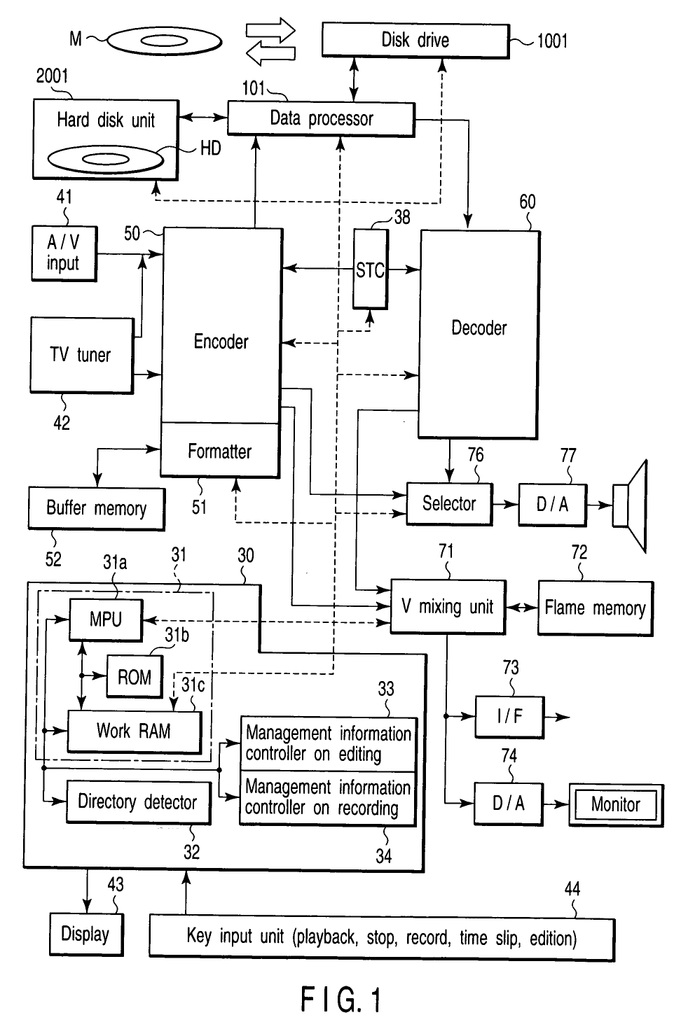

According to an embodiment, FIG. 1 shows an example of an optical disc apparatus or an information recording/playback apparatus according to an embodiment of the invention. The information recording/playback apparatus of FIG. 1 includes a personal computer (PC). The information recorded on a recording medium includes document information. The embodiment of the invention includes a digital video recorder, which will be explained hereinafter as an example of the embodiment.

FIG. 1 shows an example of an information recording/playback apparatus according to an embodiment of the invention. The information recording/playback apparatus of FIG. 1 uses a DVD-standard optical disc as a recording medium, and has a hard disc incorporated in a hard disc unit. The hard disc and DVD optical disc can be replaced by a semiconductor memory (memory card).

The information recording/playback apparatus (video recorder) 1 shown in FIG. 1 has a disc drive 1001 capable of creating a video file, in a DVD-standard medium (optical disc) M. The optical disc M may be a CD-standard disc, or HD (High Density) DVD and Blue-Ray disc with the recording capacity increased to higher than a current DVD optical disc.

The disc drive 1001 has a rotation control system which rotates an optical disc M at a predetermined speed, a laser drive system which emits a laser beam with a predetermined wavelength for playing back the information recorded in the optical disc M, and a laser optical system which guides the laser beam. These systems will not be described in detail.

The information recording/playback apparatus (video recorder) 1 can create a video file in a hard disc HD incorporated in a hard disc unit (hereinafter called a HDD) 2001.

Data (recording data) to be recorded on the optical disc loaded in the disc drive 1001 or in the hard disc HD of the HDD 2001 is recorded in a recording medium (previously specified, the optical disc M or hard disc HD) under the control of a data processor 101. By the control of the data processor 101, the recorded data is read (playback data is obtained) from the optical disc M of the disc drive 1001 or the hard disc HD of HDD 2001.

The data processor 101 handles recording or playback data as a predetermined unit, and includes a buffer circuit, a modulation/demodulation circuit, and an error correction unit.

The video recorder 1 has an encoder 50 that is a data processor for recording input information, a decoder 60 that is a data processor for playing back recorded data, and a microcomputer block 30 to control the operation of the video recorder 1, as main components.

The encoder 50 has an analog-digital converter for video and audio signals for digitizing input analog video and audio signals, a video encoder, and an audio encoder. The encoder 50 also includes a subsidiary video encoder.

The output of the encoder 50 is converted to a predetermined DVD-RAM format by a formatter 51 including a buffer memory, and supplied to the data processor 101.

The encoder 50 is supplied with external analog video and audio signals from an AV input unit 41, or analog video and audio signals from a TV tuner 42.

The encoder 50 can supply compressed digital video and audio signals directly to the formatter 51, when the compressed digital video and audio signals are directly input. The encoder 50 can also supply digital video and audio signals converted from analog signals, directly to a video mixing unit 71 and an audio selector 76.

The encoder 50 includes a not-shown video encoder. The video encoder converts a digital video signal to a digital video signal compressed at a variable bit rate based on the MPEG2 or MPEG1 standard.

The encoder 50 adopts the MPEG compressed digital video signal (I_Picture of MPEG) when recording a still image based on the DVD recording standard (DVD VR standard). The encoder 50 can also create a digital video signal compressed based on the JPEG standard.

A digital audio signal is converted to a digital audio signal compressed at a variable bit rate based on the MPEG or AC-3 standard, or a linear PCM (non-compressed) digital audio signal.

As for a subsidiary video signal, when a subsidiary video signal is directly input from the AV (Audio Video) input unit 41 (e.g., a signal from a video player having an independent output terminal for a subsidiary video signal), or when a broadcasting signal of a DVD video signal having the equivalent data structure is received by the TV tuner 42, a subsidiary video signal included in the DVD video signal is encoded (run length coding) by the subsidiary video encoder, and a bit map of the subsidiary video (subsidiary video data) is created.

The encoded digital video signal, digital audio signal and subsidiary video data are packed as a video pack, an audio pack and a subsidiary video pack in the formatter 51. The packed video pack, audio pack and subsidiary video pack are further gathered (concentrated), and converted to a format (DVD Video format) defined by the DVD-Video standard or a format (DVD VR format) defined by the DVD-Recording standard.

When recording a still image, a signal may be converted to a format defined by JPEG.

The information (video, audio and auxiliary video data packs) formatted by the formatter 51 and management information (file system) created by a MPU (CPU) 31a (shown later) are supplied to the HDD 2001 or disc drive 1001 through the data processor 101, and recorded in the hard disc HD or optical disc M. The information recorded in the hard disc HD or optical disc M can be rewritten or duplicated to each other through the data processor 101. Namely, the data already recorded in the hard disc HD can be moved to the optical disc M, or duplicated. The data recorded in the optical disc M can be moved to the hard disc HD, or duplicated.

The format according to the invention defines the unit of handling data, and facilitates edition of the data. Therefore, the data recorded in the hard disc HD or optical disc M, video objects of programs for example, can be edited by deleting some or all or synthesizing (connecting) optional number of objects.

The microcomputer block 30 includes a main control unit 31 including a MPU (Micro Processing Unit) or CPU (Central Processing Unit) 31a, a ROM (Read Only Memory) 31b holding a control program for operating the MPU (CPU) 31a and various element and control blocks of the video recorder 1, and a RAM (Random Access Memory) 31c supplying a predetermined work area secured to execute a program. The RAM 31c may be built as firmware of MPU, for example.

The microcomputer block 30 performs detection of defective place and unrecorded area, setting of information recording position, recording of UDF and setting of AV address, according to the control program stored in the ROM 31b by the MPU (CPU) 31a taking the RAM 31c as a work area.

The microcomputer block 30 has a directory detector 32, a VMG information (whole video management information) creator (not described in detail), a copying information detector, a copying/scrambling information processor (RDI processor), a packet header processor, a sequence header processor, and an aspect ratio information processor. The microcomputer block 30 includes a recording management information controller 33 (hereinafter called a recording management controller) to execute recording of data when recording information (data), and an edition management information controller 34 (hereinafter called an edition management controller) to execute edition of recorded data. The means characterized by the invention is executed as a control program by the edition management information controller 34 and recording control information controller 33.

The result of execution by the MPU (CPU) 31a to be informed to the user is displayed as OSD (On Screen Display) in a display 43 of the video recorder 1, or a monitor (connected as an external unit, described later).

The microcomputer block 30 includes a key input unit 44 to input a control signal, or an operation signal from the user to operate the video recorder 1. The key input unit 44 corresponds to operation switches provided at optional positions of the video recorder 1, and a not-shown remote controller to input an operation signal through a not-shown remote receiver. The key input unit 44 may be a personal computer to input a control signal to the video recorder 1 by a wired or wireless means or by light (including infrared-rays). Namely, regardless of the form of the key input unit 44, when the user operates the key input unit 44, recording of input video and audio signals, playback of recorded contents, or edition of recorded contents are performed.

The microcomputer block 30 controls the disc drive 1001, HDD 2001, data processor 101, encoder 50 and decoder 60 at the timing determined based on the time data from the STC (System Time Clock) 38. Recording and playback are usually executed in synchronization with the time clock from the STC 38. Other operations may be executed at the timing independent of the STC 38.

The decoder 60 includes a separator to separate and take out a pack from a DVD format signal given a pack structure, a memory used for separating a pack and processing other signals, a V-decoder to decode a main video data (video pack contents) separated by the separator, a SP decoder to decode a subsidiary video data (subsidiary video pack contents) separated by the separator, and an A-decoder to decode an audio data (audio pack contents) separated by the separator. These components will not be described in detail.

The decoder 60 has a video processor, which synthesizes a decoded subsidiary video data with a decoded main video data at a predetermined timing, and superposes a menu, a highlight button, subtitles (display of text of audio data) and other subsidiary images.

An output video signal of the decoder 60 is input to a video mixing (V mixing) unit 71. The V-mixing unit 71 synthesizes a text data (synthesized with a subsidiary video data) with a main video data. The V-mixing unit 71 is connected with a line to directly input signals from the TV tuner 42 and A/V input unit 41.

The V-mixing unit 71 is connected to a frame memory 72 used as a buffer, an I/F (Interface) 73 used to output an analog signal, and a D/A converter (Digital-Analog converter) 74 used to output a digital signal.

An audio signal (output) from the decoder 60 is input to a D/A converter (Digital-Analog converter) 77 through the selector 76 by the D/A converter 77, converted to an analog signal, and output to the outside. When a speaker is connected to the output end of the D/A converter 77 through a not-shown amplifier, for example, the user can listen to audio data (sound). The selector 76 is controlled by a select signal from the microcomputer block 30. Thus, the selector 76 can directly supply the D/A converter 77 with the digital signals from the TV tuner 42 and A/V input unit 41 (unnecessary to be processed by the encoder) passing through the encoder 50.

The formatter 51 of the encoder 50 creates various divided information during data recording, and periodically sends the information (information at the time of interruption to the beginning of GOP) to the MPU (CPU) 31a of the microcomputer block 30. The divided information includes the number of packs of VOBU, end address of I picture from the beginning of VOBU, and playback time of VOBU.

The formatter 51 supplies the MPU (CPU) 31a with the aspect ratio information from the aspect ratio information processor, at the start of recording. The MPU (CPU) 31a creates VOBU stream information (STI), based on this information. The STI includes resolution data and aspect data. Each decoder is initialized based on these data at the time of playback.

In the video recorder 1, one video file is prepared for one disc, when recording a moving image or still image based on the DVD recording standard (DVD VR standard). A unit (size) of minimal continued information is determined to prevent interruption of playback image during accessing (seeking) data. This unit is called CDA (Contiguous Data Area). The CDA size is an integer multiple of ECC (Error Correction Code) block (16 sectors), and used as a recording unit in a file system. A different file is created for each image when recording a still image, for example, an image based on the JPEG standard.

The data processor 101 receives data of VOBU unit from the formatter 51 of the encoder 50, and supplies data of CDA unit to the disc drive 1001 or HDD 2001. The MPU (CPU) 31a of the microcomputer block 30 creates management information necessary for playing back recorded data, and sends the created management information to the data processor 101, when recognizing a data recording finish command indicating the end of recording data.

The management information is recorded in a recording medium (optical disc M or hard disc HD). Therefore, at the timing of encoding, the MPU (CPU) 31a can receive information of data unit (divided information) from the encoder 50. At the time of starting recording, the MPU (CPU) 31a recognizes the management information (file system) read from the optical disc M or hard disc HD, recognizes an unrecorded area of each disc, and sets a recorded area on data in a disc through the data processor 101.

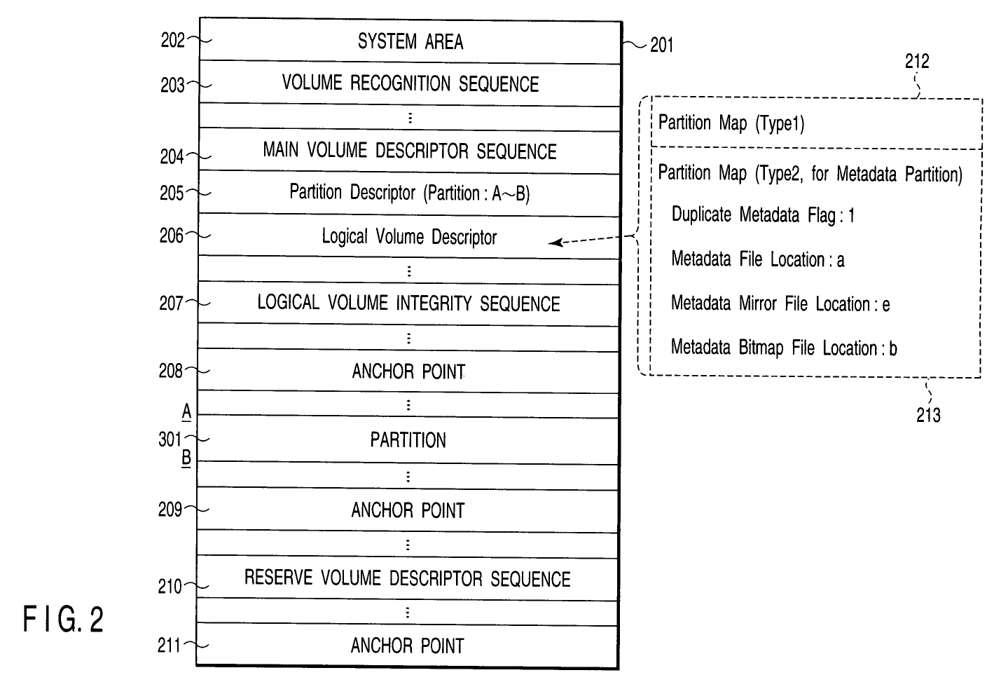

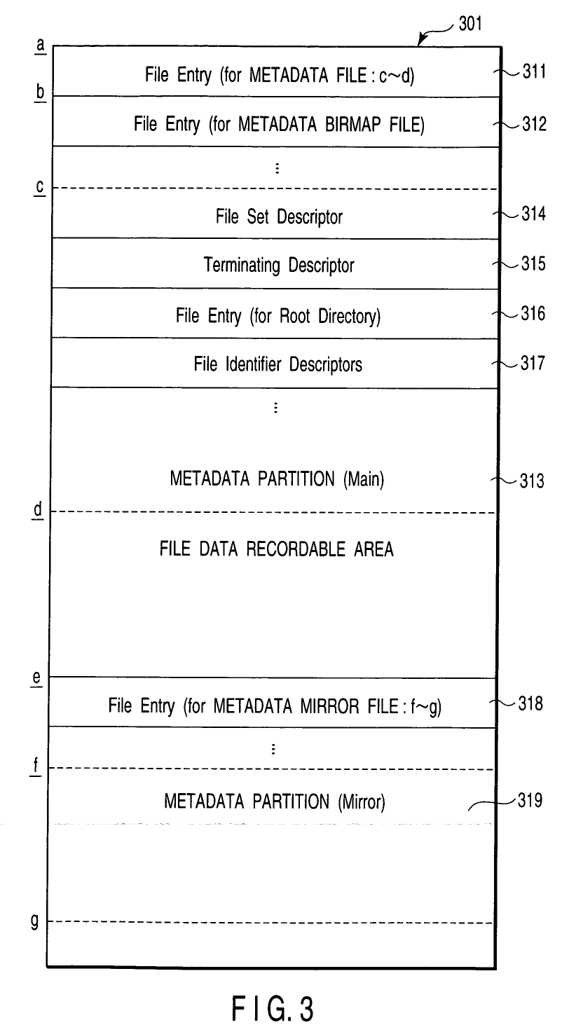

FIG. 2 and FIG. 3 schematically show the data structure defined in UDF (Universal Disc Format) Revision 2.50 (hereinafter called UDF 2.50).

FIG. 2 schematically shows the whole data structure on a recording medium. FIG. 3 schematically shows the inside of partition, which is a characteristic structure in the data structure shown in FIG. 2. In FIG. 2, [A] and [B] shown outside the frame indicate LSN (Logical Sector Number). In FIG. 3, a, b, c, . . . shown outside the frame indicate LBN (Logical Block Number) in the partition.

The configuration of the whole data structure 201 shown in FIG. 2 will be explained first.

In the whole data structure 201, a system area 202 is defined in the area other than UDF defined areas. Though not shown in FIG. 2, a system area 202 is an area with LSN values 0 to 16.

A volume recognition sequence (VRS) 203 is located next to the system area 202. Though omitted in FIG. 2, the VRS 203 includes a volume structure descriptor and a boot descriptor.

A volume descriptor sequence is defined next. The volume descriptor sequence includes a main volume descriptor sequence 204 and a subsidiary reserve volume descriptor sequence 210. These two volume descriptor sequences 204 and 210 have the same contents.

The positions of the volume descriptor sequence 204 and 210 are described in anchor volume descriptor pointers existing at anchor points 208, 209 and 211 described later.

The main volume descriptor sequence 204 will be explained as an example. The sequence 204 includes several kinds of descriptor. Explanation will be given on a partition descriptor 205 and logical volume descriptor 206.

The partition descriptor 205 is used to describe a directory, file management information, and the size and position of partition 301 that is an area to write file data. In this example, the partition 301 is defined by a LSN value in the range of A to B.

The logical volume descriptor 206 is used to describe information about a logical volume. The logical volume descriptor 206 has a data field called Partition Maps to describe information called a partition map.

In a partition map, “Type 1” 212 and “Type 2” 213 are defined. The “Type 1” partition map is defined by the ECMA 167 standard that is the base of the UDF standard. The “Type 1” partition map indicates a directory, file management information, and a normal partition to write file data. The “Type 2” partition map indicates partitions defined by other than the ECMA 167 standard. The “Type 2” partition map is used to indicate a UDF-specific partition map.

As a partition map specific to the UDF 2.50, there is a metadata partition. Namely, FIG. 2 shows the “Type 2” partition map indicating a metadata partition.

The “Type 2” partition map includes information indicating the file entry (FE) positions of metadata file, metadata mirror file, metadata bitmap file, and information such as a duplicate metadata flag indicating the existence of a metadata mirror file.

Though not shown in FIG. 2, in the UDF 2.50 standard, the “Type 2” partition map indicating a metadata partition, that is, a metadata partition map includes identifier information called “*UDF Metadata Partition” in the identifier field.

In the UDF standard, a logical volume contents use field of the logical volume descriptor 206 is used to describe the position information of a file set descriptor, which is the basis for accessing a directory and file.

Though omitted in FIG. 2, the volume descriptor sequence includes other several kinds of descriptors such as a primary volume descriptor.

Next to the volume descriptor sequence (204), a logical volume integrity sequence 207 is defined. Though omitted in FIG. 2, the logical volume integrity sequence 207 includes a logical volume integrity descriptor.

The anchor points 208, 209 and 211 include anchor volume descriptor pointers describing the position information of the main volume descriptor sequence 204 and reserve volume descriptor sequence 210, as explained before.

The anchor volume descriptor pointer is an entry to access the data of a recording medium, and the describing position is defined by the UDF standard.

In the UDF 2.50, an anchor point must exist in at least two of the following three positions
“LSN=256”,
“LSN=N−256”,
“LSN=N”
N is the last LSN.

In FIG. 2, the anchor point 208 exists at the position of “LSN=256”, the anchor point 209 exists at the position of “LSN=N−256”, and the anchor point 211 exists at the position of “LSN=N”.

Next, the inside of a partition will be briefly explained with reference to FIG. 3.

A file entry (FE) exists at the position of LBN=a, b, e described in the partition map 213 explained before.

In FIG. 3, a file entry 311 existing at the position of LBN=a, indicates a file, in which the LBN value ranges over c-d. The file that the LBN value ranges over c and d is a metadata file 313, and its inside space is called a metadata partition. This space collectively describes management information, such as a directory, a file entry for a file and a file identifier descriptor (FID).

This structure called a metadata partition is newly adopted on and after the UDF 2.50. In the conventional UDF revision, if deletion or addition of a file and directory are repeated, the management information such as FE and FID is recorded in a space area of a recording medium at that point of time, and these management information exist at scattered positions on the recording medium.

If the management information such as FE and FID are scattered on a recent blue-Ray disc using a blue laser beam and large-capacity HD DVD, the seek time becomes long. The metadata partition is adopted in the UDF 2.50 to decrease the seek time by storing the FE and FID collectively on a recording medium.

In FIG. 3, the FE 318 existing at the position of LBN=e indicates a file in which the LBN value ranges over f-g. The file in which the LBN value ranges over f-g is a metadata file [Mirror] 319.

The metadata mirror file 319 has the same contents as the metadata file 313. This is adopted in the UDF 2.50 to increase the robustness against damages of a recording medium, such as stains and damages of a disc, not included in the conventional UDF revision. Use of a metadata mirror file is optional. Use of a metadata mirror file is desirable to increase the robustness. Many systems based on the UDF 2.50 will use a metadata mirror file, but not compulsive.

Whether a metadata mirror file is used is judged by a duplicate metadata flag existing in the metadata partition map 213 described before.

When the duplicate metadata flag is set to “1”, a metadata mirror file (319) is used in addition to a main metadata file (313). When, the duplicate metadata flag is cleared (set to “0”), since a metadata mirror file does not exist.

In FIG. 3, FE 312 existing at the position of LBN=b indicates a metadata bitmap file indicating whether logical blocks in a metadata partition are used for data recording. A metadata bitmap file can exist as an independent file, or can be included in an allocation descriptors field of FE depending on standards. The example of FIG. 3 is the latter. A metadata bitmap file is included in the allocation descriptors field of FE 312, and not shown. A metadata bitmap file indicates the state of using logical blocks in a metadata partition, and is not for the whole partition 301 including a metadata partition. There is another space bitmap descriptor indicating the state of using logical block in the partition 301, but omitted in FIG. 3.

Next, a metadata file and metadata mirror file will be explained in detail. The contents of the metadata partitions of the metadata file 313 and metadata mirror file 319 are the same, and the contents of the metadata partition of the metadata file will be explained.

A metadata partition is used to describe directory information such as root directory and sub-directory, and file management information such as FE and FID. FIG. 3 shows the image immediately after initialization of a recording medium. At this point of time, only a root directory is constructed. As a sub-directory is constructed and a file is recorded, FE and FID are sequentially described in the metadata partition.

The FE and FID as file management information are described in the metadata partition, but file data is written out of the metadata partition.

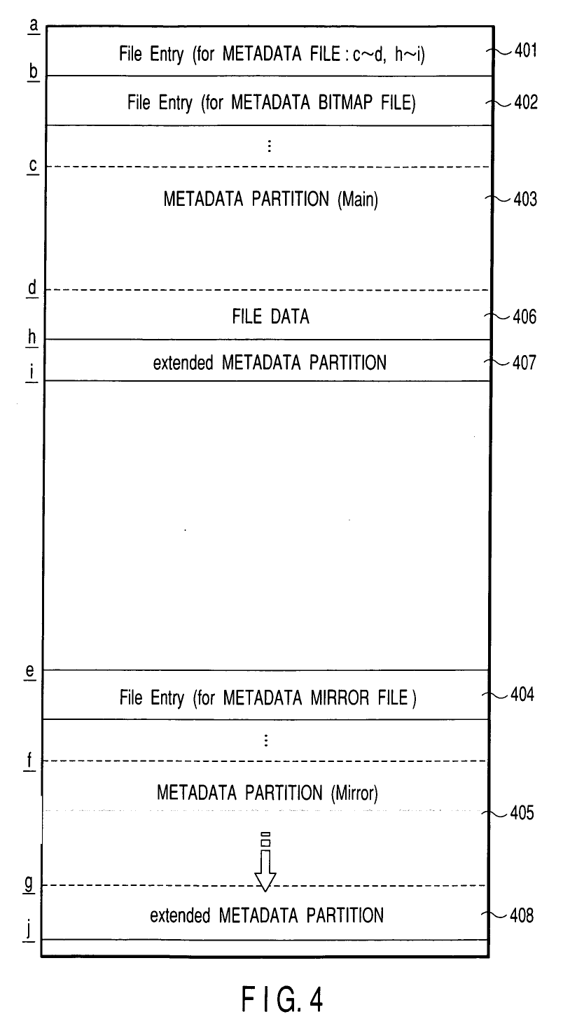

FIG. 4 shows an example of expanding a data structure by a conventional method, when a metadata partition is expanded. FIG. 4 shows only the state of the inside of the partition 301 already explained in FIG. 3. The metadata partition contents are omitted to simplify explanation.

As a new sub-directory is constructed or a new file is added on a recording medium, FE and FID as management information are added to the inside of a metadata partition. For example, when recording not only a DVD-VR standard still image but also a JPEG standard still image in DVD, one JPEG image is recorded in one file, and the number of files is increased in proportion to the number of recording still images. The number of FE and FID in a metadata partition will also be increased, and may overflow a metadata partition.

In such a case, the range of a metadata partition can be expanded to accept additional files.

The range of a metadata partition is described in the allocation descriptors field of the FE indicating a metadata file or metadata mirror file, and the range of a metadata partition can be expanded by re-setting the description of the field.

However, depending on the data recording state on a recording medium at the time of the expansion of a metadata partition, a metadata file and metadata mirror file as substance of a metadata partition are not gathered, but may be divided furthermore.

In the example of FIG. 4, the area 408 of the expanded metadata partition and a certain range can be secured for the metadata mirror file 405, and the contiguous range of LBN=f to j is described in FE 404 of the metadata mirror file, as a new metadata partition after the expansion.

Contrarily, for the main metadata partition 403 (in FIG. 4), the file data 406 is recorded in the range of LBN=d to h, and the partition is further divided into LBN=c to d and LBN=h to i, that is, two metadata files (the metadata file is divided into two).

In such a case, when accessing the metadata partition expressed by the main metadata file, it is necessary to access the divided areas of the metadata file (by several times), and the seek speed is decreased. This does not utilize the advantage of a metadata partition characteristic of the UDF 2.50, and the user's convenience is decreased, for example, the speed of accessing an optional file is decreased.

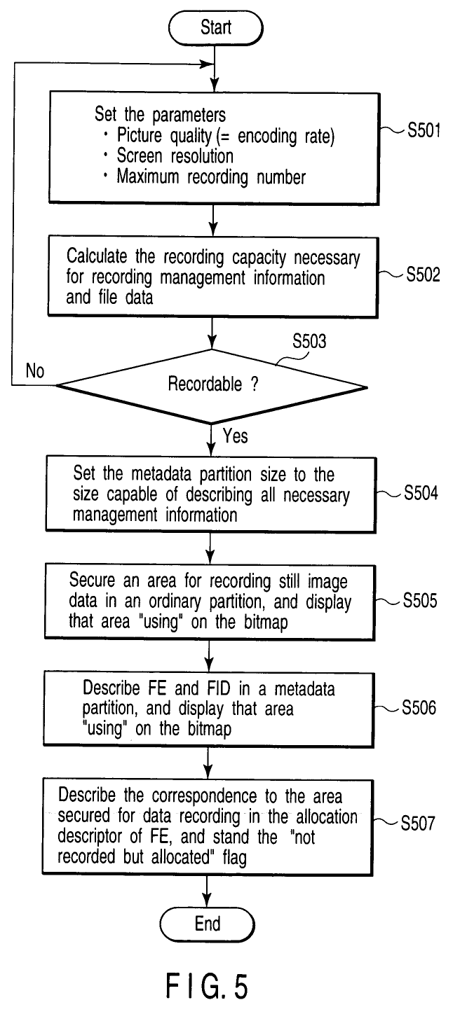

An embodiment of the invention will now be explained with reference to FIG. 5.

FIG. 5 is a flowchart showing an example of a first means embodying the invention. The flowchart of FIG. 5 shows a method of describing file management information in a recording medium, before recording a still image.

Various parameters are set in block S501.

First, set the picture quality of a recording still image. This is strictly a coding rate when compressing a still image by JPEG.

For example, a compressing object bit rate “X(bit/pixel), X is an integer”, or a prompt to input a numeric value “Compress to 1/Y, Y is an integer” as an index easy to an ordinary user, or a user interface to change a mode “Normal picture quality mode” or “High picture quality mode” can be used.

Next, set the resolution of an image. This may be a value fixed as a specification of the video recorder 1. The user may select a parameter, such as VGA size and SXGA size.

Set a maximum recording number. For example, when the whole recording medium is used for recording a still image (JPEG), a maximum recording number can be automatically set to the recordable number calculated by the residual capacity of the recording media and the picture quality and image resolution set in this block (S501). When the whole recording medium is not used only for a still image, and one DVD disc M is used for recording both still and moving images, it is possible to let the user set a maximum recording number by displaying the recordable number calculated by considering the residual capacity as a reference, taking account of the area assigned for recording a moving image.

In block S502, the recording capacity necessary for recording management information FE/FID and file data (information) is calculated, based on the parameters set in the block S501.

For example, when compressing an image by the JPEG standard, substantially the same amount of code is generated in the encoder based on the preset coding rate by the execution of in-screen rate control, though slight fluctuation occurs depending on the characteristic of an encoding screen. Therefore, it is possible to estimate a file data size per one file by giving a little allowance.

In block S503, the residual capacity of a recording media is compared with the recording capacity calculated in block S502, and whether file data can be recorded in a recording media (optical disc) M is judged. If the file (data) is judged impossible to record (S503—No) by the reason that the file (data) size is larger than the residual recording capacity (residual capacity, or size over), a series of blocks from block S501 is repeated.

If the file (data) is judged possible to record (S503—Yes), the number of still image files recordable in the recording medium (optical disc) M is determined (specified) in block S504, and the number of management information FE and FID are also determined.

In block S504, a metadata partition of the size capable of describing all management information such as FE and FID determined the numbers is set. Namely, a metadata file and metadata mirror file of the size specified (determined) to meet the number of still image files are set, and the position and size are described in the allocation descriptors field of each FE. In this time, the area set for the metadata file and metadata mirror file is displayed “using” in the space bitmap descriptor indicating the state of using the logical blocks in an ordinary partition.

In block S505, an area for recording still image data is secured outside the metadata partition and inside an ordinary partition. In this time, the secured area is displayed “using” in the space bitmap descriptor indicating the state of using the logical blocks in an ordinary partition.

In block S506, management information such as FE and FID is described inside the metadata partition set in block S504. In this time, the management information described area is displayed “using” in the space bitmap descriptor indicating the state of using the logical blocks in an ordinary partition.

Finally, in block S507, the data recording area secured in block S505 is corresponded to the management information described in block S506. Namely, the correspondence with the area secured for data recording is described in the allocation descriptors field of FE, a “not recorded but allocated” flag is stood in FE, and a series of operations is finished.

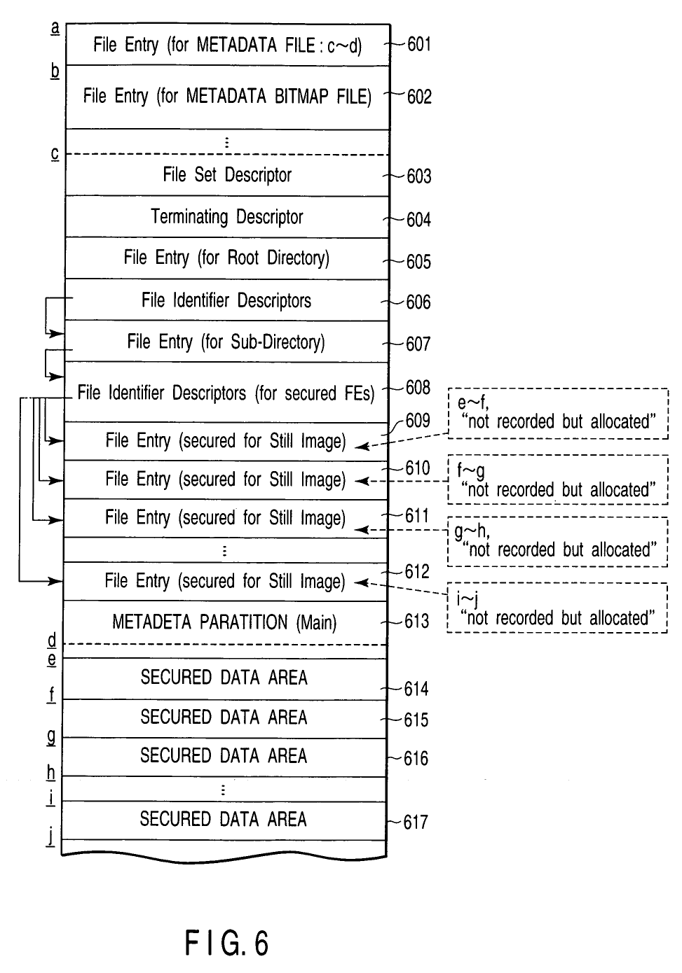

FIG. 6 shows the data structure on a recording medium at the time of the end of a series of operations shown in the flowchart of FIG. 5. As in FIG. 3, FIG. 6 shows only the inside state of the “Type 2” partition of the data structure explained in FIG. 2.

In the data structure of FIG. 6, a, b, c, . . . shown out of the frame indicate logical block number, LBN in the partition.

Between LBN=c and LBN=d, previously described FE (File Entry) 609, 610, 611, . . . , 612 are defined based on the maximum still image recording number. FID is smaller than FE, and shown collectively as a FID group 608 in FIG. 6.

The FE (609 to 612) corresponds to the area secured for recording a still image, or secured data area (hereinafter a data recording area) 614, 615, 616, . . . , 617. The FE is given a mark (flag) “not recorded but allocated” in addition to information indicating the data area (614 to 617).

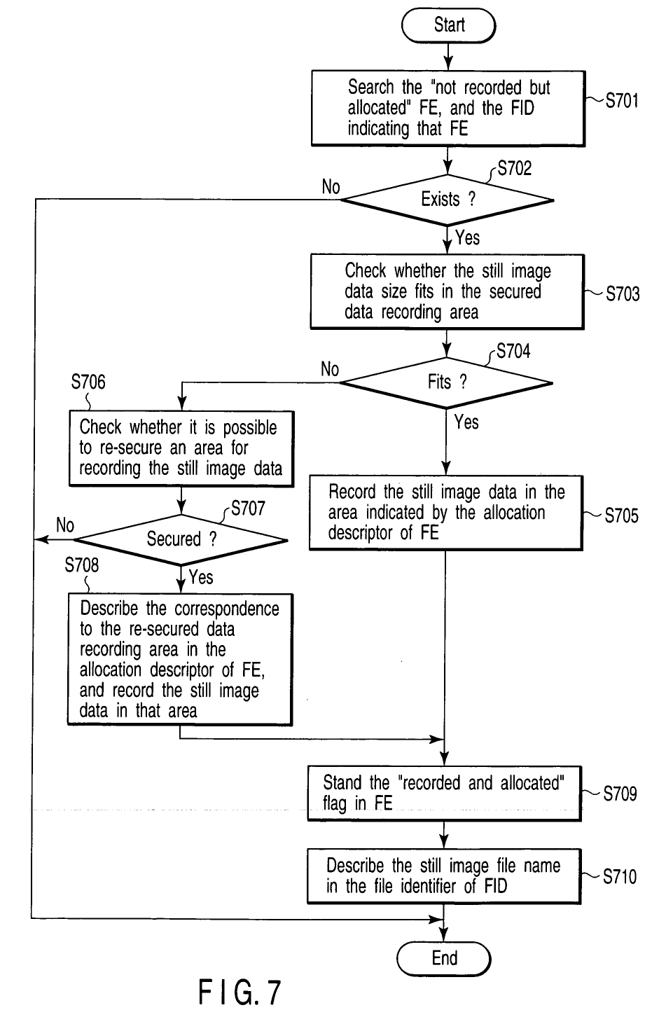

FIG. 7 is a flowchart of recording a still image. The flowchart of FIG. 7 shows a process of recording a still image in a recording medium having the file management information described previously by the process of the flowchart of FIG. 5.

First, in block S701, the FE with the “not recorded but allocated” flag and FID indicating that FE are searched.

In block S702, the operation is branched according to whether the “not recorded but allocated” flag and FID indicating that FE exist or not. If the “not recorded but allocated” flag and FID indicating that FE don't exist (S702—No), the operations of all blocks on and after the next block S703 are skipped, and a series of operations is finished. This means that the still image recording is impossible exceeding the maximum recording number.

If the “not recorded but allocated” flag and FID indicating that FE exist (S702—Yes), whether the data size of a recording still image fits in the secured still image data recording area is judged in block S703.

In this case, when a still image is encoded in the video recorder 1, the encoding is performed so that file data fits in the secured data recording area by using the parameters set in block S501 of FIG. 5.

However, when recording a JPEG image captured from a digital still camera connected as an external unit, file data may not fit in the secured data recording area.

For example, when the parameters are set assuming the recording of a still image of “normal picture mode” in block S501 of FIG. 5, if an JPEG image captured from a digital still camera connected as an external unit is in “high picture quality mode”, that JPEG image captured from a digital still camera cannot be recorded in the secured data recording area.

In block S704, the operation is branched based on the judgment in block S703. If the data size of a recording still image fits in the secured data recording area (S704—Yes), the still image data is recorded in the area specified by the allocation descriptors field of FE. Then, go to block S709.

If the data size of a recording still image does not fit in the secured data recording area (S704—No), go to block S706. In block S706, whether the still image data recording area that is re-secured in a recording medium is judged.

In the next block S707, the operation is branched based on the judgment in block S706. If the data recording area cannot be secured because of the insufficient residual capacity of a recording medium (S707—No), the operations of all blocks on and after the next block S708 are skipped, and a series of operations is finished.

If the data recording area can be secured (S707—Yes), the area to record the file data of a recording still image is secured in block S708, the correspondence with the secured area is described in the allocation descriptors field of FE, and the still image data is recorded in the secured area. Then, go to block S709.

In the former stage of block S709, the file data of still image has been recorded in a recording medium by any of blocks S705 and S708.

In block S709, the not recorded but allocated flag of FE is rewritten, and the “recorded and allocated”flag is set in FE.

Finally, in block S710, a file name is described in the file identifier field of FID indicating the FE, and a series of operations is finished.

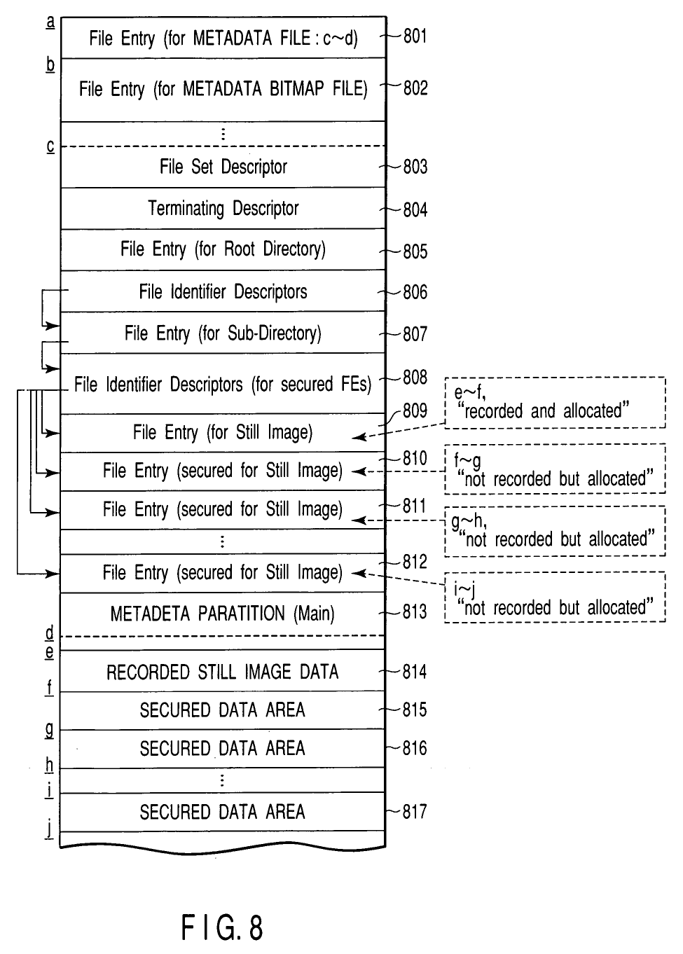

FIG. 8 schematically shows a data structure in a recording medium immediately after recording a still image according to the flowchart shown in FIG. 7. FIG. 8 shows an example of recording a data file of the size storable in the secured area for data recording. As in FIG. 3, FIG. 8 shows only the inside states of a partition of the data structure explained in FIG. 2.

In FIG. 8, the data area 814 of the secured data recording area is a recorded still image data indicating the area in which the file data of a still image is recorded. The FE 809 indicates that area.

In the FE 809, a “recorded and allocated” flag is re-set, as a still image has been recorded. The FID corresponding to this FE exists in the FID group 808, and a file name of the still image is described in the file identifier field, but omitted in FIG. 8.

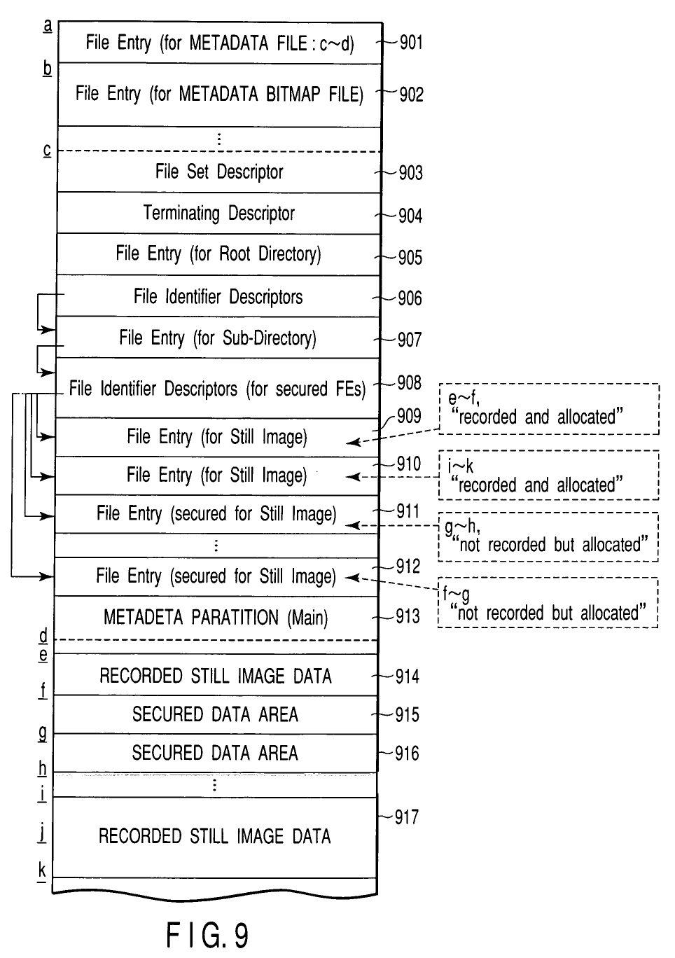

FIG. 9 schematically shows a data structure in a recording medium immediately after recording a still image, different from that of FIG. 8. FIG. 9 shows an example of recording a data file of the size not storable in the secured area for data recording. As in FIG. 3, FIG. 9 shows only the inside states of a partition of the data structure explained in FIG. 2.

The example of FIG. 9 is characterized by securing a data recording area again in a recording medium, because file data cannot be stored in the secured data recording area.

Concretely, the area given the largest logic block number is selected from the secured data recording area, and re-corresponded to the FE 910 selected as a recording object. Then, the data recording area 917 is re-set to the size recordable the file data of the object still image, and the still image file data is recorded in that area.

In the FE 910, the position and size of the re-set data recording area are described, and a “recorded and allocated” flag is set.

The FID corresponding to that FE exists in the FID group 908, and a file name of the still image is described in the not-shown file identifier field.

As described above, the file management information is previously described in a recording medium according to the flowchart of FIG. 5, and the file data of still image is recorded in an unused data recording area given a “not recorded but allocated” mark (flag) according to the flowchart of FIG. 7. Even if still images are recorded to the preset maximum number, expansion of a metadata partition is not demanded (does not occur). Namely, the possibility of dividing a metadata file and metadata mirror file can be decreased. Therefore, the user's convenience is not decreased, for example, the decreased speed of accessing an optional file caused by the decreased seek speed is prevented.

When the recorded still image number exceeds the preset maximum number and the recording is refused in block S702 of FIG. 7, it is permitted by the specification of the video recorder 1 to increase the maximum recording number by expanding a metadata partition if there is allowance in the residual capacity a recording medium, and the recording can be continued. However, in this case, there arises the possibility of dividing a metadata file and metadata mirror file depending on the state of a recorded data file.

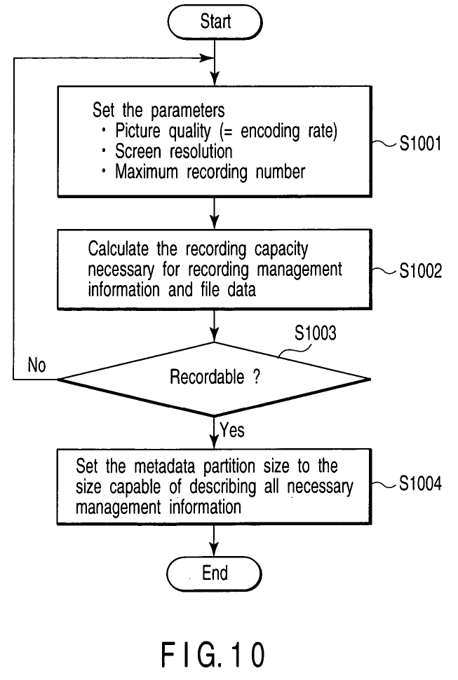

FIG. 10 is a flowchart showing an example of a second means embodying the invention. The flowchart of FIG. 10 shows a method of setting a metadata partition with the size enough to describe all management information of a still image file, before recording a still image.

In FIG. 10, various parameters are set in block S1001.

First, set the picture quality of a recording still image. This is strictly a coding rate when compressing a still image by JPEG.

For example, a compressing object bit rate “X(bit/pixel), X is an integer”, or a prompt to input a numeric value “Compress to 1/Y, Y is an integer” as an index easy to an ordinary user, or a user interface to change a mode “Normal picture quality mode” or “High picture quality mode” can be used.

Next, set the resolution of an image.

This may be a value fixed as a specification of the video recorder 1. The user may select a parameter, such as VGA size and SXGA size.

Set a maximum recording number. For example, when the whole recording medium is used for recording a still image (JPEG), a maximum recording number can be automatically set to the recordable number calculated by the residual capacity of the recording media and the picture quality and image resolution set in this block (S1001). When the whole recording medium is not used only for a still image, and one DVD disc M is used for recording both still and moving images, it is possible to let the user set a maximum recording number by displaying the recordable number calculated by considering the residual capacity as a reference value, taking account of the area assigned for recording a moving image.

In block S1002, the recording capacity necessary for recording management information FE/FID and file data (information) is calculated, based on the parameters set in the block S1001.

For example, when compressing an image by the JPEG standard, substantially the same amount of code is generated in the encoder based on the preset coding rate by the execution of in-screen rate control, though slight fluctuation occurs depending on the characteristic of an encoding screen. Therefore, it is possible to estimate a file data size per one file by giving a little allowance.

In block S1003, the residual capacity of a recording media is compared with the recording capacity calculated in block S1002, and whether file data can be recorded in a recording media (optical disc) M is judged.

If the file (data) is judged impossible to record (S1003—No) by the reason that the file (data) size is larger than the residual recording capacity (residual capacity, or size over), a series of blocks from block S1001 is repeated.

If the file (data) is judged possible to record (S1003—Yes), the number of still image files recordable in the recording medium (optical disc) M is determined (specified) in block S1004, and the number of management information FE and FID are also determined.

In block S1004, a metadata partition of the size capable of describing all management information such as FE and FID determined the numbers is set. Namely, a metadata file and metadata mirror file of the above size are set, and the position and size are described in the allocation descriptors field of each FE.

In this time, the area set for the metadata file and metadata mirror file is displayed “using” in the space bitmap descriptor indicating the state of using the logical blocks in an ordinary partition.

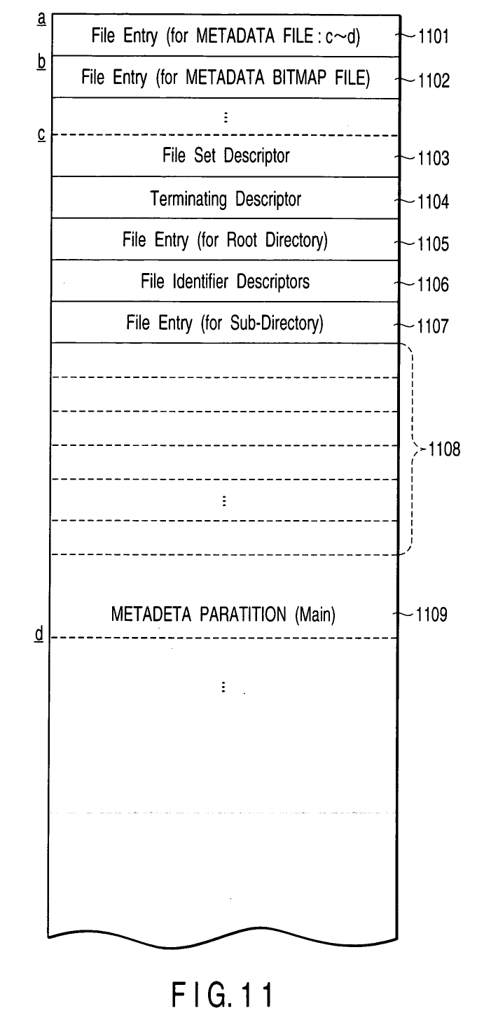

FIG. 11 shows the data structure on a recording medium at the time of the end of a series of operations shown in the flowchart of FIG. 10. FIG. 11 shows only the inside state of the partition of the data structure explained in FIG. 2.

In FIG. 11, FE and FID of a still image are described when a still image is actually recorded. An area 1108 capable of describing all FE and FID equivalent to the preset maximum recording number is previously ensured. Further, a metadata file 1109 having the size enough to describe all the management information is set in a recording medium.

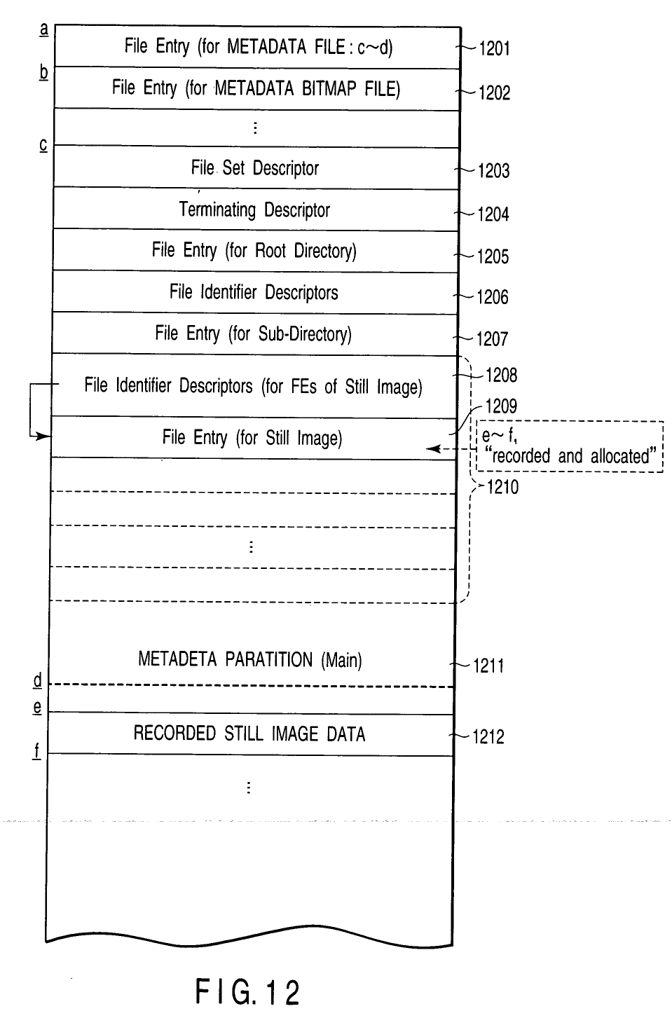

FIG. 12 schematically shows the state immediately after recording a still image in the data structure of a recording medium shown in FIG. 11.

In FIG. 12, FE and FID as management information are described in a metadata partition when a still image is recorded. The FE 1209 is the FE of a recorded still image. The corresponding file data 1212 is recorded out of a metadata partition.

The FID of this file is described in the FID group 1208 painted black, and the file name is described in the file identifier field, as in the data structure described before.

As described above, by previously setting a metadata partition of enough size in a recording medium according to the flowchart of FIG. 10, the metadata partition is not expanded even if a still image is recorded up to a preset maximum number.

Therefore, the possibility of dividing a metadata file and metadata mirror file can be decreased. This prevents the decrease of user's convenience, for example, a speed of accessing an optional file is not decreased by a decreased seek speed.

As explained hereinbefore, according to the present invention, management information such as FE and FID is previously described, JPEG image data is recorded in an allocated recording area, and sequential increase of the management information FE/FID is prevented. This can also be achieved by decreasing an element to expand a metadata partition, in the case that management information FE and FID are gradually increased.

Even if a metadata partition needs to be expanded, the possibility of dividing a metadata file is decreased. Therefore, a decrease in a seek speed is prevented, and a decrease in the speed of accessing an optional file is prevented, which decreases the user's convenience.

Namely, by the means according to the invention, expansion of metadata partition does not occur even if a still image is recorded up to a preset maximum number, and the possibility of dividing a metadata file and metadata mirror file is decreased.

This can prevent an access speed decrease, even if a lot of still image file is recorded in the next-generation optical disc (HD DVD, Blue-Ray) capable of holding several thousands to several ten thousands JPEG still images.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

The embodiments may be embodied in other specific forms without departing from its spirit or essential characteristics. A digital video recorder is taken as an example of the invention. Other apparatus, for example, a personal computer (PC) may be available as an information recording/playback according to the invention. Further, embodiments may be embodied in a moving image camera using an optical disc as a recording medium and portable acoustic apparatus containing music data.

What is claimed is:

1. A video recorder for recording a still image in a recording medium comprising:
describing management information of a still image in a recording medium before recording a still image, and allocating a data recording area to the management information; and
recording data of a recording still image in the data recording area allocated to the described management information, when recording a still image.

2. A video recorder for recording a still image in a recording medium comprising:
securing a contiguous area for describing management information corresponding to all of assumed recording still image files in a recording medium before recording a still image; and
describing management information in the secured contiguous area, and recording data of a recording still image in a data recording area allocated to the management information, when recording a sill image.

3. A video recorder for recording a still image in a recording medium comprising:
securing a contiguous area with a size enough to describe management information corresponding to a still image file, before recording a still image; and
describing management information in the secured contiguous area, and recording data of a recording still image in a data recording area allocated to the management information, when recording a still image.

4. A video recording method comprising:
setting a management information recording area with a size enough to write management information of optional number of files defined based on a data size of a recording image, in a recording medium configured to hold file data; and
securing a data recording area for recording optional number of files by corresponding to the set management information recording area.

5. The video recording method according to claim 4, wherein the management information recording area for writing the file management information is contiguously defined.

6. The video recording method according to claim 5, wherein the management information recording area for writing the file management information is defined to a size enough to record management information of all optional number of files defined based on a data size of a recording image

7. The video recording method according to claim 4, wherein a data size of a recording image is set depending on a picture quality of a still image.

8. The video recording method according to claim 5, wherein a data size of a recording image is set depending on a picture quality of a still image.

9. The video recording method according to claim 6, wherein a data size of a recording image is set depending on a picture quality of a still image.

10. An information recording/playback apparatus which records file data in a predetermined data structure in a recording medium, and plays back the data from the recording medium as requested, comprising:
a means for controlling writing of management information data, which sets a management information recording area including at least one management information for managing file data, in a recording area different from an area for recording file data of a recording medium, as a management information recording area with a size enough to write management information of optional number of files defined previously based on a size of recording file data; and
a management information recording means, which writes management information associated with recorded file data in a management information recording area set by the means for controlling writing of management information data, when recording file data in a recording medium.

11. The information recording/playback apparatus according to claim 10, which records file data in a predetermined data structure in a recording medium, and plays back the data from the recording medium as requested, wherein a size of the management information recording area is defined contiguously to a size enough to record management information of all recording images.
